(19) United States
(12) Patent Application Publication
(10) Pub. No.: US 2010/0085315 A1
(43) Pub. Date: Apr. 8, 2010

(54) Flat touch panel

(75) Inventor: Lung-Sheng Hsih, Taipei (TW)

Correspondence Address: BACON & THOMAS, PLLC, 625 SLATERS LANE, FOURTH FLOOR, ALEXANDRIA, VA, 22314-1176, US

(73) Assignee: MINLEAD LTD., Taipei (TW)

(21) Appl. No.: 12/457,309

(22) Filed: Jun. 8, 2009

(30) Foreign Application Priority Data
Oct. 7, 2008 (TW) 097217932

(51) Int. Cl. G06F 3/041

(52) U.S. Cl. 345/173

(57) ABSTRACT

A flat touch panel has a top and bottom substrate, a top and bottom transparent conductive film formed on the corresponding first and second substrates and a FPC mounted on a bottom face of the bottom substrate. At least one top conductive line is formed on the top transparent conductive film. Multiple bottom conductive line is formed on the bottom face of the second substrate. The top conductive line is electronically connected to the corresponding terminal of the FPC through the conductive material in the first through holes. The bottom transparent conductive film is electronically connected to the corresponding terminals of the FPC through the second through holes with the material and the bottom conductive lines. Since the bottom conductive lines and the FPC are directly formed on the bottom face of the bottom substrate, the flatness of the touch panel is good and the visible area is increased.

### BACKGROUND OF THE INVENTION

1. Field of the Invention

The present invention relates to a touch panel, and more particularly to a flat touch panel with a flexible printed circuit mounted outside the touch panel.

2. Description of Related Art

The touch panel is used to mount on a monitor of a computer and used as an input device for the computer. In general, the touch panel and the monitor are assembled in a frame. The touch panel is further electronically connected to the computer, so a flexible printed circuit board (hereinafter FPC) is mounted to the panel circuit and used to connect to a signal converter. Therefore, the computer obtains the coordinate data through the signal converter.

There are many types of the touch panel, such as Resistive type, Capacitive type, Ultrasonic type or IR type. The resistive and capacitive type touch panels require higher flatness than others.

With reference to FIG. 7, a conventional four-line transistive type touch panel (3) is used as an example to explain why the flatness is required. The resistive type touch panel has a first substrate (30), a first ITO film (31), a second ITO film (33), a second substrate (34) and a FPC (32). The first ITO film (31) is mounted on a bottom face of the first substrate (30) and the second ITO film (33) is mounted on a top face of the second substrate (34). Two X conductive lines (331) are formed on two opposite X axle peripheries of the first ITO film (31) and two first leading lines (312) are formed on a Y axle periphery and respectively connected to the X conductive lines (311). Two Y conductive lines (331) are formed two opposite Y axle peripheries of on the second ITO film (33). One second leading line (332a) is an L-shaped line connected to one Y axle conductive line (331) and the other second leading line (332b) is connected to the other Y axle conductive line (331). The first and second leading lines (311, 332) are formed on the same Y axle periphery. One end of the FPC (32) is aligned to ends of the first and second leading lines (312) (332a, 332b) and then sandwiched between the first and second substrates (30, 34). Further, multiple spacers (not shown) are formed between the first and second ITO films (31, 33) when the first and second substrates (30, 34) are combined.

With further reference to FIG. 8, a top view of the resistive type touch panel (3) of FIG. 7 is shown. The X axle and Y axle conductive lines (311, 331) and the first and second leading lines (312, 332a, 332b) are not overlapped to prevent lines from being short, so a visible area of the touch panel (3) is not further increased. In addition, since the FPC (32) has a specific thickness, a portion of touch panel (3) corresponding to the end of the FPC (32) is raised from the top face of first substrate (30). Therefore, the touch panel (3) does not have a flat face. The uneven face of the touch panel causes the touch panel not to secure the frame.

Recently some electronic devices require other geometric shapes of the display and touch panel, such as circular or elliptic etc., to match the outline of a casing of the electronic device. With further reference to FIG. 9, in general the first substrate (30) and the second substrate are rectangular, so a top casing of the electronic device is further defined an elliptic opening (40). When the top casing is covered on the rectangular touch panel (3), the electronic device has an elliptic touch panel. However, portions of the visible area covered by the top casing are useless.

### SUMMERY OF THE INVENTION

The main objective of the present invention is to provide a flat touch panel that has a flat face to easily and securely mounted on a frame and the visible area are increased.

A flat touch panel has a top and bottom substrate, a top and bottom transparent conductive film formed on the corresponding first and second substrates and a FPC mounted on a bottom face of the bottom substrate. At least one top conductive line is formed on the top transparent conductive film. Multiple bottom conductive line is formed on the bottom face of the second substrate. The top conductive line is electronically connected to the corresponding terminal of the FPC through the conductive material in the first through holes. The bottom transparent conductive film is electronically connected to the corresponding terminals of the FPC through the second through holes with the material and the bottom conductive lines. Since the bottom conductive lines and the FPC are directly formed on the bottom face of the bottom substrate, the flatness of the touch panel is good and the visible area is increased.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment of a flat touch panel in accordance with the present invention;

FIG. 2 is a cross sectional view in partial of the flat touch panel taken along 2-2 line of FIG. 1;

FIGS. 3a is a cross sectional view in partial of the flat touch panel taken along 3-3 line of FIG. 1;

FIGS. 3b is another cross sectional view in partial of the flat touch panel taken along 3-3 line of FIG. 1;

FIG. 4 is a cross sectional view in partial of the flat touch panel taken along 4-4 line of FIG. 1;

FIG. 5 is an exploded perspective view of a second embodiment of a flat touch panel in accordance with the present invention;

FIG. 6 is an exploded perspective view of a third embodiment of a flat touch panel covered by a top casing in accordance with the present invention;

FIG. 7 is an exploded perspective view of a conventional touch panel in accordance with the prior art;

FIG. 8 is a top view of FIG. 7; and

FIG. 9 is an exploded perspective view of the touch panel covered by a top casing.

### DETAILED DESCRIPTION OF THE PREFERRED EMBODIMENT

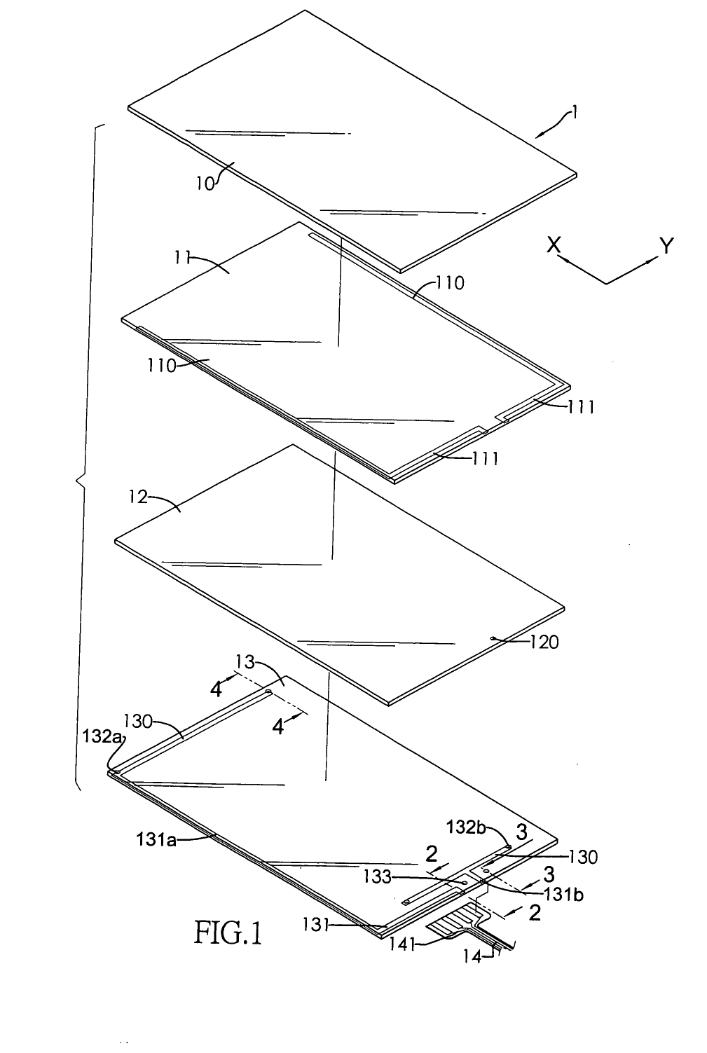

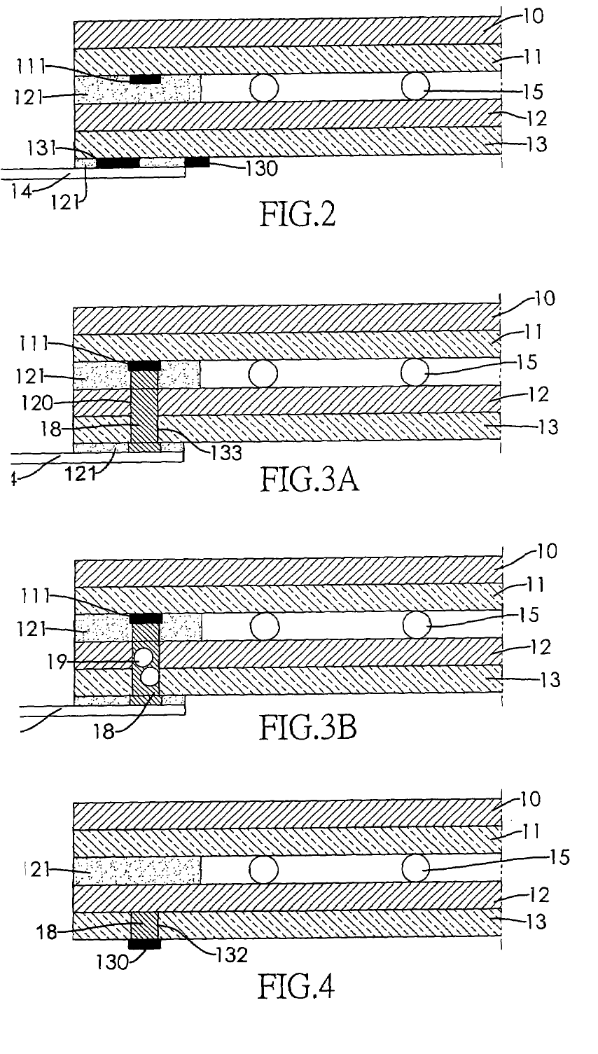

With reference to FIGS. 1 and 2, a first embodiment of a flat touch panel (1) is a four-line type and resistive type touch panel. The touch panel (1) has a first substrate (10), a second substrate (13), a top transparent conductive film (11), a bottom transparent conductive film (12), multiple spacers (15), two X axle conductive lines (110), two Y axle conductive lines (130), two first leading lines (111), two second leading lines (131a, 131b) and a flexible printed circuit board (FPC) (14). The top transparent conductive film (11) is formed on a bottom face of the first substrate (10).

The two X axle conductive lines (110) are respectively formed on two opposite X axle peripheries of a bottom face of the top transparent conductive film (11). The two first leading lines (111) are formed on one Y axle periphery of the bottom face of the top transparent conductive film (11) and one end of each first leading lines (111) are connected to the corresponding X axle conductive line (110). The other ends of the first leading lines (111) are further extended to an edge of the Y axle periphery.

With further reference to FIG. 3A, the bottom transparent conductive film (12) is formed on a top face of the second substrate (13) and has two through holes (120) corresponding to two free ends of the first leading lines (111) on the edge of the Y axle periphery.

The two Y axle conductive lines (130) are respectively formed on two opposite Y axle peripheries of a bottom face of the second substrate (13). The second leading lines (131a, 131b) are formed on the bottom face of the second substrate (13). One of the two second leading lines (131a) is L-shaped and one end of which is connected to one end of the corresponding Y axle conductive line (130). One end of the other second leading line (131b) is connected to the other Y axle conductive line (130). The free ends of the second leading lines (131a, 131b) are further extended to an edge of the Y axle periphery corresponding to the Y axle periphery of the top transparent conductive film (11).

With reference to FIG. 3A, the second substrate (13) has two first through holes (133), two second through holes (132a) and two third through holes (132b). The first through holes (133) are communicated with the two through holes (120) of the bottom transparent conductive film (120). The two second through holes (132a) are corresponding to the two ends of the Y axle conductive line (130). The two third through holes (132b) are corresponding to the two ends of the other Y axle conductive line (130). Each of the second and third through holes (132a, 132b) is filled with conductive material, such as epoxy (18). The first through holes (133) and the two through holes (120) of the bottom transparent conductive film (12) are filled with the epoxy (18), too. With reference to FIG. 3B, multiple metal balls (19) is put inside the through holes (120, 133, 132a, 132b) and then the epoxy (133) is further filled with the through holes (120, 133, 132a, 132b). In a preferred embodiment, an anisotropic conductive film (ACF) (121) is formed on four peripheries of the bottom transparent conductive film (12) to combine the first and bottom transparent conductive films (11, 12). Therefore, the epoxy (18) in the first through holes (133) and the through holes (120) of the bottom transparent film is electronically connected to the ends of the first leading lines (111) on the top transparent conductive film (11). The epoxy (18) in the second through holes (132a) are electronically connected between one Y axle conductive line (130) and the corresponding Y axle periphery of a bottom face of the bottom transparent conductive film (12). The epoxy (18) in the third through holes (132b) are used to electronically connect between the other Y axle conductive line (130) and the other Y axle periphery of the bottom face of the bottom transparent conductive film (12), as shown in FIG. 4.

With further reference to FIG. 2, the FPC has four top terminals (141) corresponding to the first through holes (133) and the ends of the two second leading lines (131a). The FPC (14) is mounted on the bottom face of the second substrate (13) and electronically connected to the ends of the two second leading lines (131a, 131b) and the epoxy (18) in the first through holes (131). In a preferred embodiment, an ACF (121) is formed on the four terminals of the FPC (14). The FPC (14) is fixed on the bottom face of the second substrate (13) and the four terminals (141) are able to electronically connect to the corresponding ends of the second leading liens (131a, 131b) and the epoxy (18) in the first through holes (133).

Based on the foregoing description, the two Y-axle conductive lines (130) the two second leading lines (131a, 131b) are directly formed on the bottom face of the second substrate (13). The X axle and Y axle conductive lines (110, 130) are closed to edges of the peripheries, so the visible area of the touch panel (1) is increased. Further, the FPC (14) is also directly mounted to the bottom face of the second substrate (13). Therefore, a flatness of the touch panel (1) is good after the first and second substrates (10, 13) are combined. Since the first embodiment of the touch panel (1) is resistive type, the spacers (15) are formed between the first and bottom transparent conductive films (11, 12) when the first and second substrates (10, 13) are combined.

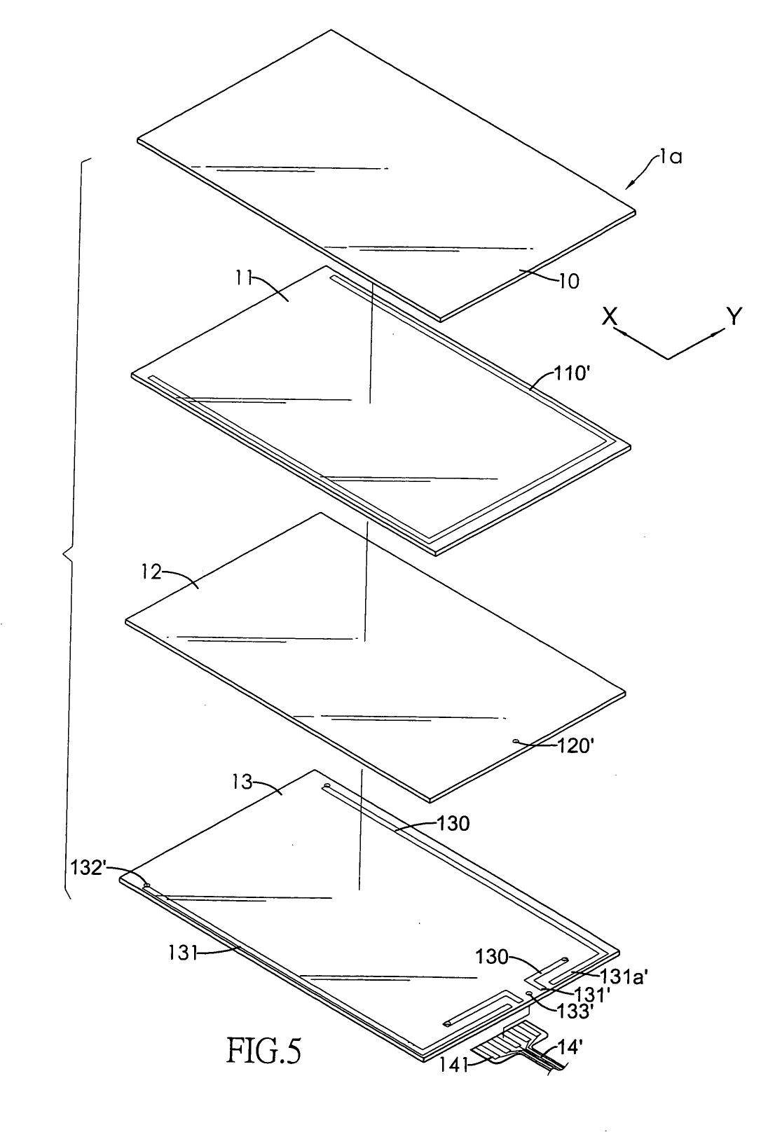

With reference to FIG. 5, a second embodiment of the touch panel (1a) is a five-line type and resistive type and is similar to the first embodiment. The touch panel (1a) also has a first substrate (10), a second substrate (13), a top transparent conductive film (11), a bottom transparent conductive film (12), multiple spacers (not shown), a top conductive line (110′), four bottom conductive lines (130′), four leading lines (131a′) and a FPC (14).

The top conductive line (110′) is form on three peripheries of a bottom face of the top transparent conductive film (11). The four bottom conductive lines (130′) are formed on a bottom face of the second substrate (13). Two of the bottom conductive lines (130′) are formed on the X axle peripheries and the other two of the bottom conductive lines (130′) are formed on one Y axle periphery. Two of the four leading lines (131′) are formed on the same Y axle periphery and connected to ends of the corresponding X axle conductive lines (130′). The other two of the four leading lines (131′) are formed on the same Y axle periphery and connected to ends of the corresponding Y axle conductive lines (130′). The free ends of the four leading lines are extended to an edge of he Y axle periphery to correspond to four terminals (141) of the FPC (14′).

Since the FPC (14′) is mounted to the bottom of the second substrate (13), the top conductive line (110′) has to be electronically connected to the corresponding to the terminal (141) of the FPC (14′). Therefore, two first through holes (120′, 133′) are respectively defined on the bottom transparent conductive film (12) and the second substrate (13) and corresponding to the top conductive line (110′). Further, since the four bottom conductive lines (130′) are formed on the bottom face of the second substrate (13), four second through holes (132′) are defined on the second substrate (13) and respectively corresponding to free ends of the four bottom conductive lines (130′).

The first through holes (120′, 133′) and the second through holes (132′) are filled with the epoxy, or metal balls may be further put inside the through holes. Therefore, the four bottom conductive lines (130′) are electronically connected to the bottom transparent conductive film (12). When the first substrate (10) with the top transparent conductive film (11) and the second substrate (13) with the bottom transparent conductive film (12) are combined by the ACF. Therefore, the terminal (141) of the FPC (14′) is electronically connected to the top conductive line (110′) through epoxy in first through holes (120′, 133′) and the ACF.

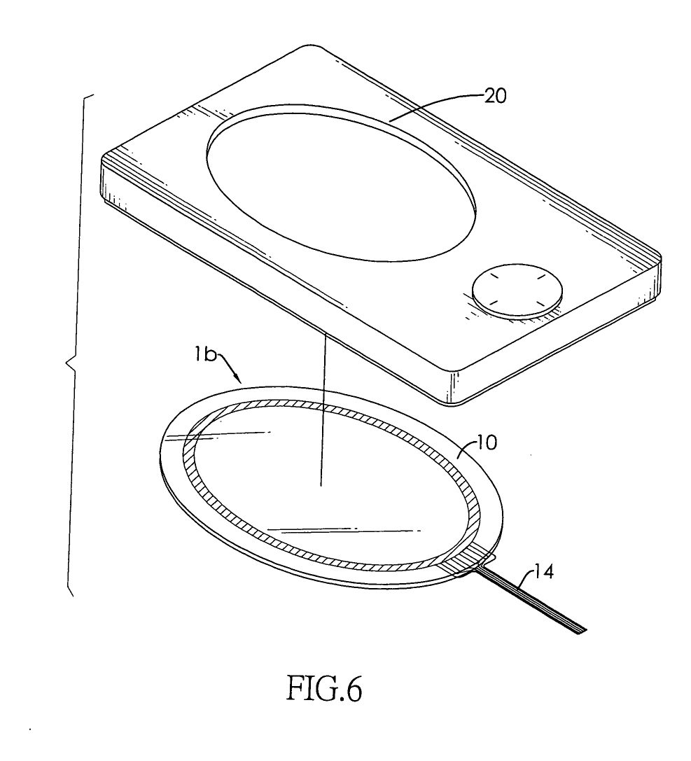

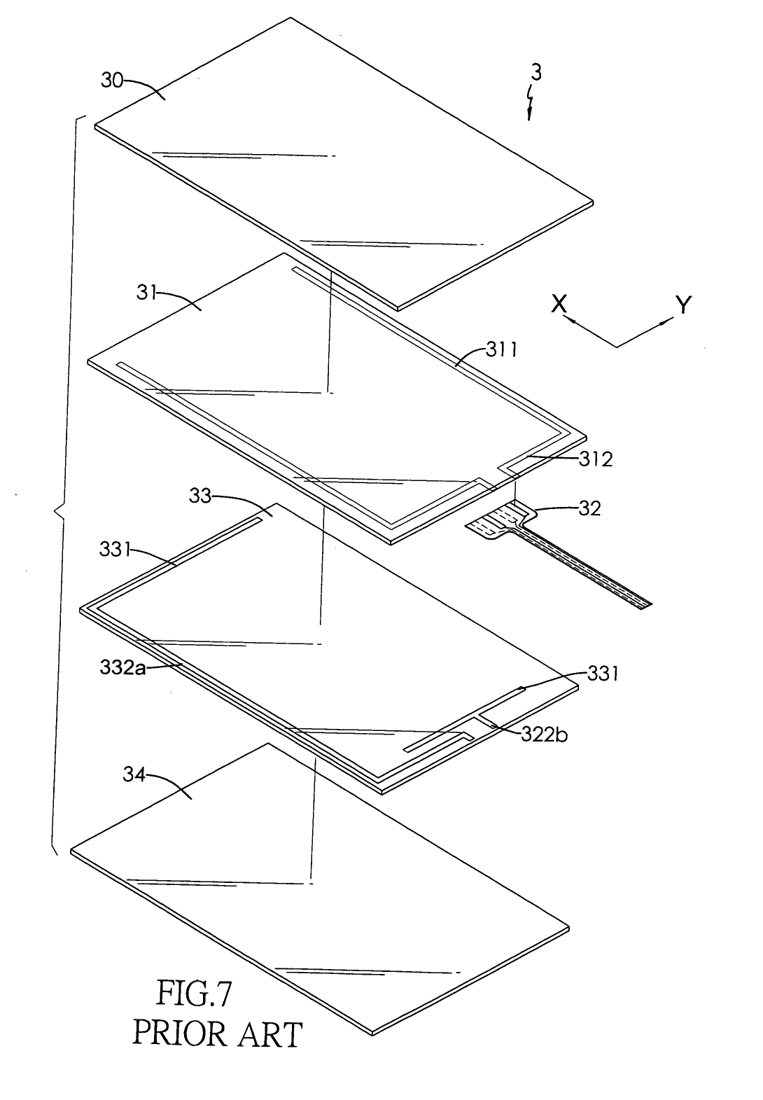

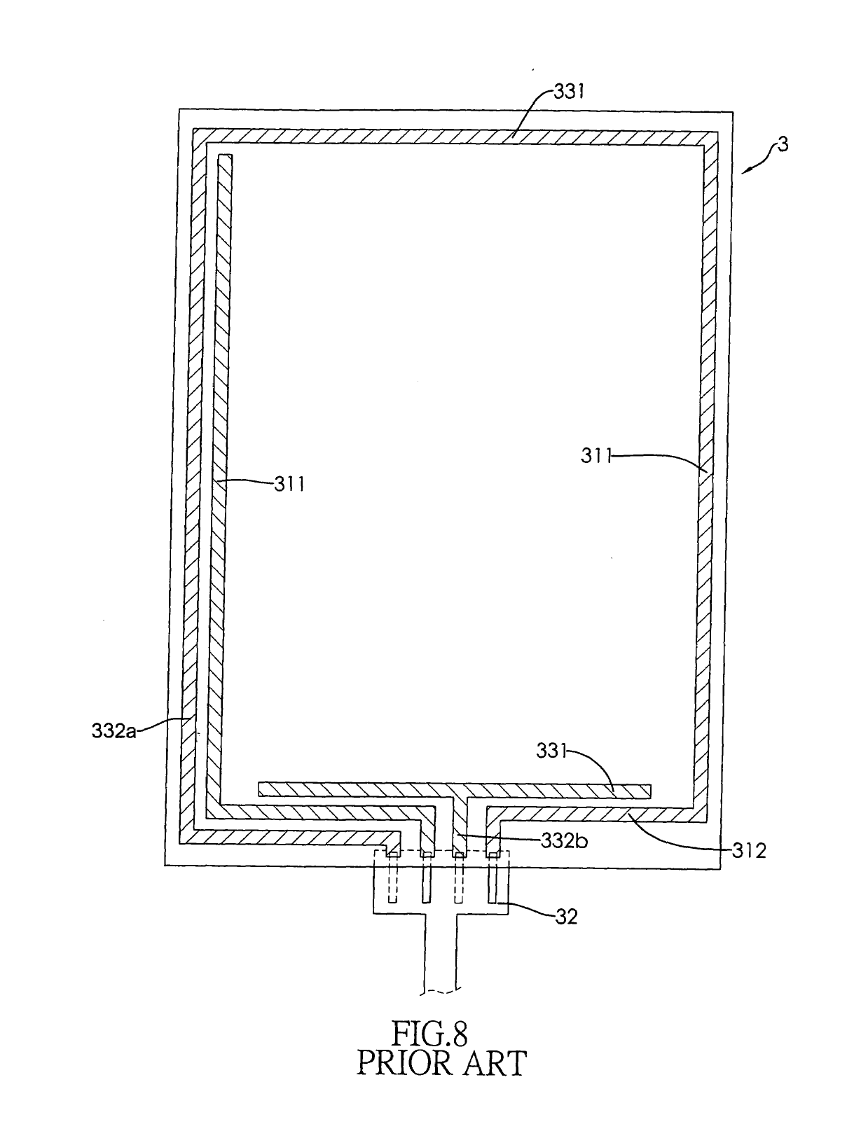

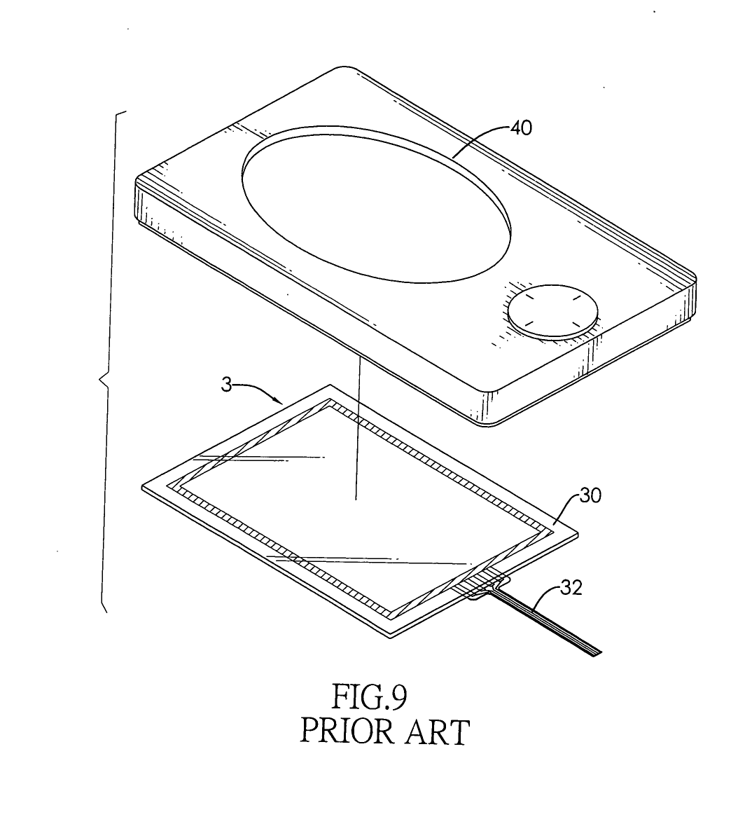

With reference to FIG. 6, a third embodiment of the touch panel (1b) matches to opening (20) shape of a top casing of an electronic device. That is, outlines of the first substrate (10) and the second substrate, and the top and bottom transparent conductive films are matched to the opening (20) shape of the top casing. Therefore, the touch panel (1b) does not occupy inside space of the electronic device and makes the manufacturing cost down.

Based on the foregoing description, the present invention provides the FPC is directly the bottom face of the resistive type touch panel. Further, some conductive lines, such as silver lines are formed on the bottom face of the touch panel. Therefore, the present invention not only has an large enough visible area, but also has good flatness.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A flat touch panel comprising:
a first substrate having a first top face and a first bottom face;
a second substrate having a second top face facing to the first bottom face and a second bottom face, wherein multiple bottom conducting lines are formed on the second bottom face of the second substrate;
a top transparent conductive film formed on the first bottom face of the first substrate, and at least one top conductive line formed on the top transparent conductive film;
a bottom transparent conductive film formed on the second top face of the second substrate and combined to the top transparent conductive film, wherein spacers are formed between the top transparent conductive film and the bottom conductive film;
at least one first through holes defined through the bottom transparent conductive film and the second substrate, corresponding the top conducting line, and filled with conductive material to electronically connect to the top conducting line bottom transparent conductive film;
multiple second through holes defined through the second substrate, being adjacent to the at least one first through hole, corresponding to ends of the bottom conducting lines and filled with the conductive material to electronically connect to the bottom transparent conductive film; and
a flexible printed circuit board having multiple terminals, mounted to the second bottom face of the second substrate, wherein the multiple terminals are electronically connected to the conductive material of the corresponding first and second through holes.

2. The flat touch panel as claimed in claim 1, further comprising multiple metal balls being respectively inside of each of the first and second through holes.

3. The flat touch panel as claimed in claim 2, wherein the conductive material is epoxy.

4. The flat touch panel as claimed in claim 3, wherein the top and bottom transparent conductive films are combined by anisotropic conductive film so as to electronically connect the at least one top conducting line and the corresponding terminal of the flexible printed circuit board.

5. The flat touch panel as claimed in claim 4, wherein the FPC is mounted to the second bottom face of the second substrate so as to electronically connect the terminals and the corresponding top and bottom conductive lines.

6. The flat touch panel as claimed in one of claims 1, wherein
the top transparent conductive film has four peripheries and the top conductive line is formed on the four peripheries;
the second bottom face of the second substrate has two X axle peripheries and two Y axle peripheries;
two of the multiple bottom conductive lines are formed on the two X axle and one Y axle peripheries and each of which has an X axle segment and an Y axle segment, wherein free ends of the two Y axle segment is corresponding to the second through holes; and
other two of the multiple bottom conductive lines are formed on the Y axle segment and free ends of which are corresponding to the other second through holes.

7. The flat touch panel as claimed in one of claims 2, wherein
the top transparent conductive film has four peripheries and the top conductive line is formed on the four peripheries;
the second bottom face of the second substrate has two X axle peripheries and two Y axle peripheries;
two of the multiple bottom conductive lines are formed on the two X axle and one Y axle peripheries and each of which has an X axle segment and an Y axle segment, wherein free ends of the two Y axle segment is corresponding to the second through holes; and
other two of the multiple bottom conductive lines are formed on the Y axle segment and free ends of which are corresponding to the other second through holes.

8. The flat touch panel as claimed in one of claims 3, wherein
the top transparent conductive film has four peripheries and the top conductive line is formed on the four peripheries;
the second bottom face of the second substrate has two X axle peripheries and two Y axle peripheries;
two of the multiple bottom conductive lines are formed on the two X axle and one Y axle peripheries and each of which has an X axle segment and an Y axle segment, wherein free ends of the two Y axle segment is corresponding to the second through holes; and
other two of the multiple bottom conductive lines are formed on the Y axle segment and free ends of which are corresponding to the other second through holes.

9. The flat touch panel as claimed in one of claims 4, wherein
the top transparent conductive film has four peripheries and the top conductive line is formed on the four peripheries;
the second bottom face of the second substrate has two X axle peripheries and two Y axle peripheries;
two of the multiple bottom conductive lines are formed on the two X axle and one Y axle peripheries and each of which has an X axle segment and an Y axle segment, wherein free ends of the two Y axle segment is corresponding to the second through holes; and
other two of the multiple bottom conductive lines are formed on the Y axle segment and free ends of which are corresponding to the other second through holes.

10. The flat touch panel as claimed in one of claims 5, wherein
the top transparent conductive film has four peripheries and the top conductive line is formed on the four peripheries;
the second bottom face of the second substrate has two X axle peripheries and two Y axle peripheries;
two of the multiple bottom conductive lines are formed on the two X axle and one Y axle peripheries and each of which has an X axle segment and an Y axle segment, wherein free ends of the two Y axle segment is corresponding to the second through holes; and
other two of the multiple bottom conductive lines are formed on the Y axle segment and free ends of which are corresponding to the other second through holes.

11. The flat touch panel as claimed in one of claims 1, wherein
the top transparent conductive film has two X axle peripheries and two Y axle peripheries;
two top conductive lines are formed on the corresponding X axle peripheries;
the second bottom face of the second substrate has two X axle peripheries and two Y axle peripheries, wherein the second through holes are defined the Y axle periphery and the flexible printed circuit board is mounted on the Y axle periphery; and
two bottom conductive lines are formed on the two X axle and one Y axle peripheries of the second bottom face and each of which has an Y axle segment and a leading line connected between end of the Y axle segment and the corresponding terminal of the flexible printed circuit board.

12. The flat touch panel as claimed in one of claims 2, wherein
the top transparent conductive film has two X axle peripheries and two Y axle peripheries;
two top conductive lines are formed on the corresponding X axle peripheries;
the second bottom face of the second substrate has two X axle peripheries and two Y axle peripheries, wherein the second through holes are defined the Y axle periphery and the flexible printed circuit board is mounted on the Y axle periphery; and
two bottom conductive lines are formed on the two X axle and one Y axle peripheries of the second bottom face and each of which has an Y axle segment and a leading line connected between end of the Y axle segment and the corresponding terminal of the flexible printed circuit board.

13. The flat touch panel as claimed in one of claims 3, wherein
the top transparent conductive film has two X axle peripheries and two Y axle peripheries;
two top conductive lines are formed on the corresponding X axle peripheries;
the second bottom face of the second substrate has two X axle peripheries and two Y axle peripheries, wherein the second through holes are defined the Y axle periphery and the flexible printed circuit board is mounted on the Y axle periphery; and
two bottom conductive lines are formed on the two X axle and one Y axle peripheries of the second bottom face and each of which has an Y axle segment and a leading line connected between end of the Y axle segment and the corresponding terminal of the flexible printed circuit board.

14. The flat touch panel as claimed in one of claims 4, wherein
the top transparent conductive film has two X axle peripheries and two Y axle peripheries;
two top conductive lines are formed on the corresponding X axle peripheries;
the second bottom face of the second substrate has two X axle peripheries and two Y axle peripheries, wherein the second through holes are defined the Y axle periphery and the flexible printed circuit board is mounted on the Y axle periphery; and
two bottom conductive lines are formed on the two X axle and one Y axle peripheries of the second bottom face and each of which has an Y axle segment and a leading line connected between end of the Y axle segment and the corresponding terminal of the flexible printed circuit board.

15. The flat touch panel as claimed in one of claims 5, wherein
the top transparent conductive film has two X axle peripheries and two Y axle peripheries;
two top conductive lines are formed on the corresponding X axle peripheries;
the second bottom face of the second substrate has two X axle peripheries and two Y axle peripheries, wherein the second through holes are defined the Y axle periphery and the flexible printed circuit board is mounted on the Y axle periphery; and
two bottom conductive lines are formed on the two X axle and one Y axle peripheries of the second bottom face and each of which has an Y axle segment and a leading line connected between end of the Y axle segment and the corresponding terminal of the flexible printed circuit board.
